(19) United States
(12) Patent Application Publication
(10) Pub. No.: US 2010/0196729 A1
(43) Pub. Date: Aug. 5, 2010

(54) Autoclave Cure Cycle Design Process and Curing Method

(76) Inventors: Stephen Mark Whiteker, Covington, KY (US); Lisa Vinciguerra Shafer, Cincinnati, OH (US); Warren Rosal Ronk, West Chester, OH (US); William Evan McCormack, West Chester, OH (US); Joseph Thomas Begovich, JR., West Chester, OH (US)

Correspondence Address: GENERAL ELECTRIC COMPANY, GE AVIATION, ONE NEUMANN WAY MD F16, CINCINNATI, OH, 45215, US

(21) Appl. No.: 12/363,741

(22) Filed: Jan. 31, 2009

(51) Int. Cl. B32B 27/04; B05D 3/00

(52) U.S. Cl. 428/473.5; 427/296

(57) ABSTRACT

Method includes forming a preform utilizing a polyimide resin-impregnated fiber-reinforced layers; removing solvent from the system at initial vacuum, pressure, and temperature conditions for an initial time interval sufficient to remove substantially all the solvent; imidizing the polyimide resin system under second vacuum, pressure, and temperature conditions for a second time interval sufficient to substantially completely imidize the polyimide resin; consolidating the preform following imidization under third vacuum, pressure, and temperature conditions and including applying pressure to the preform when the preform is at a predetermined temperature; and solidifying the preform under fourth vacuum, pressure, and temperature conditions to provide a cured laminate structure having a shape of a turbine engine component. A method is provided for designing the polyimide resin overall cure cycle dependent on the desired outcome at the solvent removal stage, the imidization stage, the consolidation stage, and the solidification stage.

### BACKGROUND OF THE INVENTION

This invention relates generally to polyimide resin systems, and more specifically to cure cycle design processes and curing methods.

High temperature thermosetting polyimide resin systems typically synthesize polymer molecules in-situ from monomeric reactants, oligomers, or a combination. The polymer synthesis reactions may be associated with several species of volatiles such as water, methanol, ethanol, and the like. Impurities in the materials may induce significant side reactions that produce undesirable volatiles. Further, the reaction process includes cross-linking of the synthesized polymers to achieve a desired glass transition temperature (Tg) and full consolidation. It is desired to provide sufficient cross-linking without creating defects such as wrinkle, porosity, and delaminations.

Currently, polyimide parts can be difficult to process. During the overall cure cycle, the temperature, pressure and vacuum profiles must be balanced to yield low porosity, highly stabile composites. Improper cure cycles can lead to trapped volatiles, incomplete crosslinking or other unintended by-products that provide less capable composite parts.

Accordingly, it would be desirable to have a cure cycle design process for high temperature polyimide resin systems to enable adequate solvent removal, reaction completion, volatiles removal, and minimal resin bleed-out during polymer creation and cross-linking to achieve desired final reaction products.

### BRIEF DESCRIPTION OF THE INVENTION

The above-mentioned need or needs may be met by exemplary embodiments that provide methods for fabricating a turbine engine composite component. An exemplary method comprises impregnating a plurality of fiber-reinforced layers with a polyimide resin system carried in a solvent to form a preform; removing the solvent from the polyimide resin system by subjecting the preform to initial vacuum, pressure, and temperature conditions for an initial time interval sufficient to remove substantially all the solvent, wherein the initial vacuum and temperature conditions are controlled to prevent greater than about 2% resin bleed-out during solvent removal; imidizing the polyimide resin system following solvent removal by subjecting the preform to second vacuum, pressure, and temperature conditions for a second time interval sufficient to substantially completely imidize the polyimide resin system, wherein the second vacuum and temperature conditions are controlled to remove substantially all reaction-generated volatiles and to attain a targeted viscosity of the polyimide resin system during imidization; consolidating the preform following imidization by subjecting the preform to third vacuum, pressure, and temperature conditions and applying pressure to the preform when the preform is at a predetermined temperature, wherein the third vacuum and temperature conditions are controlled to attain a targeted fiber volume fraction; and solidifying the preform following consolidation by subjecting the preform to fourth vacuum, pressure, and temperature conditions to provide a cured laminate structure having a shape of a turbine engine component.

Exemplary embodiments disclosed herein include a turbine engine composite component formed by the exemplary method described above.

Exemplary embodiments include methods for designing a cure cycle for fabricating a composite component comprising a polyimide resin system. The cure cycle includes a solvent removal portion, an imidization portion, a consolidation portion, and a solidification portion. An exemplary method of designing a cure cycle comprises: determining a plurality of first relationships between applied vacuum verses mass flow rate to model solvent removal for a preselected polyimide resin system; determining a plurality of second relationships between time for 95% reaction completion verse temperature to model imidization reaction kinetics for the preselected polyimide resin system; determining a plurality of third relationships between reaction temperatures, time until pressure is applied, applied pressure level, and heating rates to model consolidation for the preselected polyimide resin system; determining a plurality of fourth relationships between heating rates, stress behavior, and component geometry to model solidification for the preselected polyimide resin system; and using the relationships determined in (a)-d) to provide an overall cure cycle including vacuum, pressure, and temperature conditions for the polyimide resin system.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 provides a schematic representation of a typical cure cycle showing a temperature, vacuum, and pressure schedule.

### DETAILED DESCRIPTION OF THE INVENTION

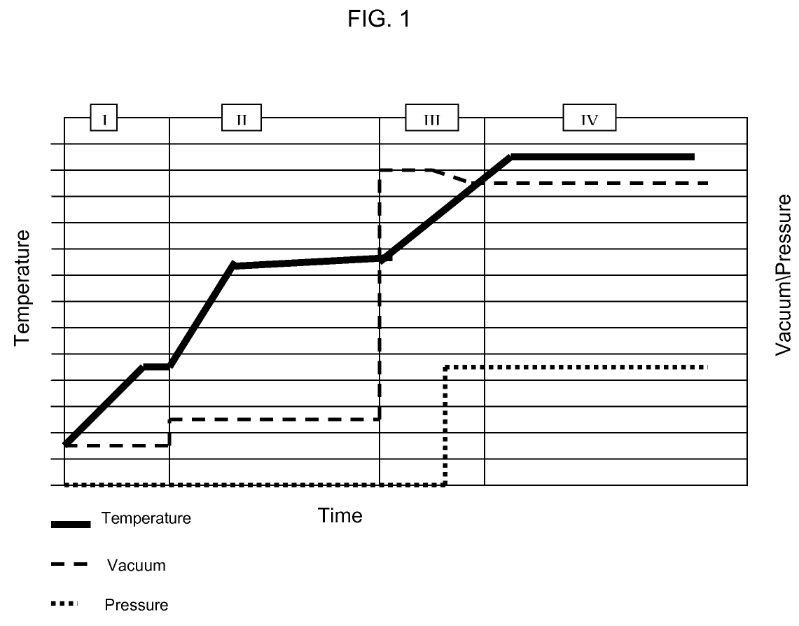

Referring to the drawings wherein identical reference numerals denote the same elements throughout the various views, FIG. 1 provides a schematic representation of an exemplary cure cycle for a high temperature polyimide resin system.

Generally, there are four key stages in a cure cycle for high temperature polyimide resin systems. For purposes of this disclosure, the four stages are identified as: Stage I: Solvent Removal; Stage II: Polymerization (e.g., imidization); Stage III: Consolidation; and Stage IV: Solidification, as identified in FIG. 1. Throughout a typical cure cycle, the controllable process parameters are temperature, vacuum, and pressure. These parameters may be adjusted throughout the process to yield the overall cure cycle. The exemplary cure cycle design process is presented with respect to a part precursor, or preform, including a plurality of prepreg plies to be cured and/or shaped in an autoclave, wherein the part precursor is encased by a typical “bag.” Methods for autoclave bagging and the like are well known in the art. It is believed that the principles disclosed herein may be applicable to other curing methods. With proper tooling designs, it is believed that the cure cycles disclosed herein may be adapted to other composite manufacturing processes such as vacuum assisted resin transfer molding (VARTM), solvent assisted resin transfer molding (SARTM), resin film infusion (RFI) processes. The overall cure process for a given polyimide resin system may depend on the part thickness and/or geometry. Part thickness depends on the number of stacked prepreg plies used to form the preform. As used herein, the “relatively thin” of “thin” parts include from 1-12 prepreg plies and “relatively thick” or “thick” parts include greater than 12 prepreg plies.

In an exemplary embodiment, Stages 1-4 are modeled based on the physics of the process. The quantitative results of the models are then used to develop an overall process that satisfies quality requirements. The overall process must also be robust in view of material and process variations.

Stage 1: Solvent Removal. During Stage 1, it is desired that nearly all (>99%) of the solvent be removed. It is also desired that there is no significant build-up of pressure underneath the bag so that part structure remains intact and undisturbed (pressure on part >0). Another requirement is the removal of volatiles (generally solvents/water) without undesirable levels of resin bleed-out (resin bleed-out<2%).

During Stage 1, the heating schedule generally comprises a ramp and hold cycle. For simplicity, the stage will be described as “a ramp” and “a hold” although any combination of ramps/holds is contemplated within the scope of this disclosure. For a given heating schedule (ramp/hold), solvents are generated or released and gas pressure builds to create a pressure gradient. The volatiles may be vented through vacuum ports. For the heating schedule, vacuum verses mass flow rate curves can be generated taking into account the volatile generation rate, bubble growth and gas pressure, preform thickness, pressure gradients in the preform, permeability and compressibility of the preform, etc. The information can be utilized in the process design to provide adequate vacuum level for the given heating cycle. The process design may include an applied vacuum verses time profile that allows for variable vacuum conditions rather than restriction to a constant value. In general, the hold duration is sufficient to allow for the removal of substantially all the solvent in Stage 1. The applied vacuum is controlled to prevent excessive resin flow, or resin bleed-out, which would result in resin-starved laminates.

Stage 2: Polymerization. During Stage 2 the monomeric or oligomeric reactants react to produce multiple species of by-products (volatiles) and create one or more polymers of targeted molecular weight. Key drivers for Stage 2 also include volatile removal, similar to Stage 1. However, the volatiles removed in Stage 2 are generally reaction products, and not evaporating solvents/water as in Stage 1. During Stage 2, the desired outcomes include substantially complete monomer reaction (>95%); no build-up of pressure underneath the bag (pressure on part>0) for the entire heat cycle; removal of volatiles without substantial resin bleed-out (resin bleed-out<2%); and attainment of target degree of polymerization (evidenced by viscosity being greater than a predetermined value).

In the process design, the kinetics of polymerization are characterized to allow for completion of the monomer reaction. Sufficient hold time is provided to complete the reaction. For example, simple design curves at different temperatures can plot Time (for 95% polymerization) verses Temperature for a given material system. An optimized hold time and temperature can be provided in the overall cure cycle. Again, the removal of reaction-generated volatiles and pressure on the part are controlled as in Stage 1 to meet the design criteria for Stage 2.

Stage 3: Consolidation. During Consolidation, the polymer melts and begins the cross-linking process. Resin viscosity initially decreases with increasing temperature. As the cross-linking reaction starts, the molecular weight increases exponentially, viscosity increases, and the material goes into a glassy phase. For a given resin system, models based on viscosity measurements and cross-linking kinetics are used to evaluate different thermal cycles for viscosity behavior. In Stage 3, the desired outcomes include minimized resin loss (<2%), a full-consolidated part having a targeted fiber volume fraction characterized by a porosity of less than 3%, and no delaminations.

For minimizing resin loss and attaining full consolidation, the key parameters include the temperature at which pressure is applied, pressure level, and heating rate. From a porosity standpoint, the timeliness of pressure application is important. If pressure is applied too early while secondary reactions are still producing volatiles, the porosity increases, especially on the tool side. If application of pressure is delayed too long, there may not be enough resin flow for full consolidation.

When pressure is applied, load is initially transferred to the resin which flows to fill the unfilled regions and fiber volume fraction increases. The fabric compressibility allows the fibers to share some of the applied pressure. The fiber load share increases exponentially with the fiber volume fraction. If pressure is applied too late, there will not be adequate resin flow, resulting in porosity. Too much resin squeezed out during consolidation may lead to connected porosity or delamination as the resin shrinks during final crosslinking.

Stage 4: Solidification. During solidification, in which the part is finally shaped, the part is able to accumulate stresses. The residual stresses should be minimized during solidification so that the part does not fail when it is released from the tool. During Solidification, the desired outcomes include minimum stress on tool-side plies and minimum stress through part thickness.

Primary parameters driving the stress are part and tool temperature at gel point, defined as the state when the part has enough modulus to start accumulating stresses. These stresses are related to the heating rate, especially for parts having thick regions. Surface stress on the tool-side is released then the part is removed from the tool. The surface stress can cause deformation and ultimately damage if not managed. Through-thickness stress is developed due to thermal gradients and shrinkage. For a given resin system/part geometry arrangement, heating rates and stress behavior can be modeled to optimize process parameters during Solidification.

Thus, the design of overall cure cycles for high temperature polyimide resin systems includes management of resin bleed, volatiles removal, extent of polymerization, consolidation, and part stresses.

In the examples that follow, a prepolymer blend may be used to form reinforced prepreg plies that when cured under suitable cure conditions yield a laminate composite part. An exemplary resin system may include a first prepolymer component and a second prepolymer component. The first prepolymer component may include a first polyimide oligomer having the formula: E₁-[R₁]ₙ-E₁ or a monomeric mixture, M₁ The second prepolymer component may include a monomeric mixture, M₂, a second polyimide oligomer having the formula E₂-[R₂]ₙ-E₂, or combinations thereof. In the oligomers, E₁ and E₂ independently comprise crosslinkable functional groups, n comprises from about 1 to about 5, and R₁ and R₂ independently comprise the following structure:

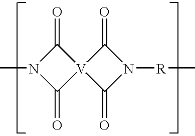

where V is a tetravalent substituted or unsubstituted aromatic monocyclic or polycyclic linking structure and R is a substituted or unsubstituted divalent organic radical. Additionally, M₁ and M₂ each comprise a diamine component comprising at least one diamine compound, a dianhydride component comprising at least one dianhydride compound, and an end group component comprising at least one end group compound.

### EXAMPLE 1

### Thin Panels

An overall cure cycle is provided for an exemplary polyimide resin system. The cure cycle may be adjusted according to the geometry of the part to be formed. For thin panels, an exemplary cure cycle includes the following steps:

Stage 1: Solvent Removal: (Using Lagging Thermocouple, LOTC, for Control) Set vacuum at 2.5″ of Hg, Heat at 1 F/min to 185 F, When LOTC reaches 175 F, start 185 F hold, Hold at 185 F for 2 hours;

Stage 2: Imidization: Heat at 0.3 F/min to 260 F; When LOTC reaches 250 F, set vacuum to 5″ Hg; Heat at 1 F/min to 480 F, Start 480 F hold when LOTC reaches 470 F, Hold at 480 F for 5 hours;

Stage 3: Consolidation: Heat at 0.5 F/min to 530 F, Pressurize to 200 psi at 5 psi/min when LOTC reaches 500 F, When pressure reaches 25 psi, turn off vacuum and vent to atmosphere;

Stage 4: Solidification: Heat at 1.5 F/min to 625 F, Start 625 F hold when LOTC reaches 615 F, Hold at 625 F for 6 hours; Cool at .5 F/min to 550 F; Cool at 1 F/min to 500 F; Cool at 3 F/min to 150 F.

### EXAMPLE 2

An alternate exemplary overall cure cycle includes: Set vacuum at 5″ Hg; Heat at 2 F/min to 190 F, Hold at 190 F for 1 hour; Heat at 2 F/min to 220 F, Hold at 220 for 1.5 hours, Heat at 2 F/min to 450 F , Increase vacuum to full when T=400 F, Hold at 450 for 3 hours, Heat at 1 F/min to 600 F Put on pressure when lagging thermocouple reaches 470 F at 10 psi/min, Start 600 F hold when average TC reaches 590 F, Hold at 600 F for 6 hours; Cool at 0.5 F/min to 550 F; Cool at 1 F/min to 500 F; Cool at 3 F/min to 150 F.

### EXAMPLE 3

A modified cure cycle may be used for thicker parts or for complex geometries. The overall cure cycle may include: Set vacuum at 5″ Hg; Heat at 1 F/min to 190 F; Heat at 0.2 F/min to 220 F, Heat at 1 F/min to 340 F, Heat at 0.3 F/min to 380 F, Heat at 1 F/min to 440 F, Increase vacuum to full when T=400 F, Heat at 0.2 F/min to 470 F Put on pressure when lagging thermocouple reaches 470 F at 10 psi/min, heat at 1 F/min to 600 F, Hold at 600 F for 6 hours, Cool at 0.5 F/min to 550 F; Cool at 1 F/min to 500 F, Cool at 3 F/min to 150 F.

### EXAMPLE 4

An alternate cure cycle may be used for thicker parts or for complex geometries. The overall cure cycle may include: Set vacuum at 5″ Hg; Heat at 3 F/min to 190 F, Hold at 190 F for 1 hour. Heat at 3 F/min to 220 F, Hold at 220 F for 1 hour. Heat at 3 F/min to 360 F, Hold at 360 F for 1 hour. After 1 hour at 360 F, increase vacuum to full. Heat at 3 F/min to 480 F, Hold at 480 F for 90 minutes. Heat at 3 F/min to 510 F, Hold at 510 F for 30 minutes. Put on 200 psi pressure after 30 minutes at 510 F at 10 psi/min while heating at 1 F/min to 540 F. Vent at 30 psi, Hold at 540 F for 3 hours. Heat at 1 F/min to 580 F, Hold at 580 F for 2 hours. Heat at 1 F/min to 610 F, Hold at 610 F for 3 hours. Cool at 0.5 F/min to 450 F. Cool at 1 F/min to 350 F. Cool at 4 F/min to 140 F.

### EXAMPLE 5

For an exemplary polyimide resin system, an alternate overall cure cycle includes (for thin panels): Set vacuum at 2-4″ Hg, Heat at 2 F/min to 190 F, Hold at 190 F for 1.5 hours, Ramp at 2 F/min to 220, Hold at 220 for 1.5 hour, Ramp at 2 F/min to 484 F, Increase vacuum to full when temperature reaches 440 F. Maintain full vacuum until the end of the cycle, Hold at 480 F for 3 hours, Ramp at 2 F/min to 575 F, Hold at 575 for 45 minutes, Ramp at 1 F/min to 650 F, When lagging thermocouple reaches 595 F, pressurize to 200 psi at 10 psi/min, Hold at 650 F for 5 hours, Cool at 0.5 F/min to 610 F, Cool at 1 F/min to 550, Cool at 3 F/min to 400 F.

### EXAMPLE 6

For the exemplary polyimide resin system of Example 5, a modified overall cure cycle for thicker panels or complex geometries includes: Set vacuum at 5″ Hg, Heat at 1 F/min to 190 F, Heat at 0.2 F/min to 220 F, heat at 1 F/min to 340 F, heat at 0.3 F/min to 380 F, heat at 1 F/min to 460 F, Increase vacuum to full when T is 440 F, Heat at 0.2 F/min to 490 F, Heat at 1 F/min to 650 F, Apply pressure at 10 psi/min when lagging thermocouple reaches 470 F, Hold at 650 F for 6 hours, Cool at 0.5 F/min to 610 F, Cool at 1 F/min to 500, Cool at 3 F/min to 150 F.

The exemplary resin systems may include a first prepolymer component that may comprise a powder including a reaction product (oligomer) of end-capping agent NE, BTDA, metaphenylene diamine (meta PDA), and 4,4′-(1,3-phenylene-bis(1-methylethylidene))bisaniline (bis-M). One commercially available prepolymer corresponding to the above polyimide oligomer is MM 9.36 available from Maverick Corporation, Blue Ash, Ohio. Alternately, the first prepolymer component may be a monomeric mixture.

The second prepolymer component may be a monomeric mixture including a diamine component which may include 4,4′-(1,3-phenylene-bis(1-methylethylidene))bisaniline (bis-M), 1,4-phenylenediamine (para-PDA), derivatives thereof, and mixtures thereof. The monomeric mixture may further include a dianhydride component which may include 3,4,3′,4′-benzophenonetetracarboxylic dianhydride (BTDA), 3,4,3′,4′-biphenyltetracarboxylic dianhydride (BPDA), derivatives thereof, and mixtures thereof. An end group component may include monomethyl ester of 5-norbornene 2,3-dicarboxylic acid (NE), derivatives thereof, and mixtures thereof.

Another exemplary resin system may include a first prepolymer component which comprises a reaction product of a dianhydride such as 2,3-3′,4′-biphenyltetracarboxylic dianhydride (a-BPDA), derivatives thereof, and mixtures thereof, one or more diamine selected from an amino phenoxy benzene (APB), metaphenylene diamine (meta-PDA), derivatives thereof, and mixtures thereof, and an end group selected from phenyl ethynyl phtalic anhydride (PEPA), derivatives thereof, and mixtures thereof. The second prepolymer component may comprise a monomeric mixture including a dianhydride component including a pyromellitic dianhydride, 3,4,3′,4′-biphenyltetracarboxylic dianhydride (BPDA), and/or 3,4,3′,4′-benzophenonetetracarboxylic dianhydride (BTDA), derivatives thereof, and mixtures. The diamine component may include 1,4-phenylenediamine (para-PDA) and/or amino phenoxy benzene (APB), derivatives thereof, and mixtures thereof. The end group component may include phenyl ethynyl phtalic anhydride (PEPA), derivatives thereof, and mixtures thereof.

The disclosed cure cycle design process may thus be utilized to provide overall cure cycles for polyimide resin systems. The design process models each stage of the process to optimize the desired outcomes. Exemplary cure cycles disclosed herein may be utilized to fabricate high performance/temperature resistant resin matrix composite structures. The exemplary cure cycle design process enables adequate solvent removal, reaction completion, volatiles removal, and minimal resin bleed-out during polymer creation and cross-linking to achieve desired final reaction products

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for fabricating a turbine engine composite component comprising:
impregnating a plurality of fiber-reinforced layers with a polyimide resin system carried in a solvent to form a preform;
removing the solvent from the polyimide resin system by subjecting the preform to initial vacuum, pressure, and temperature conditions for an initial time interval sufficient to remove substantially all the solvent, wherein the initial vacuum and temperature conditions are controlled to prevent greater than about 2% resin bleed-out during solvent removal;
imidizing the polyimide resin system following solvent removal by subjecting the preform to second vacuum, pressure, and temperature conditions for a second time interval sufficient to substantially completely imidize the polyimide resin system, wherein the second vacuum and temperature conditions are controlled to remove substantially all reaction-generated volatiles and to attain a targeted viscosity of the polyimide resin system during imidization;
consolidating the preform following imidization by subjecting the preform to third vacuum, pressure, and temperature conditions and applying pressure to the preform when the preform is at a predetermined temperature, wherein the third vacuum and temperature conditions are controlled to attain a targeted fiber volume fraction; and
solidifying the preform following consolidation by subjecting the preform to fourth vacuum, pressure, and temperature conditions to provide a cured laminate structure having a shape of a turbine engine component.

2. The method according to claim 1 wherein the polyimide resin system includes:
a first prepolymer component comprising a monomeric mixture of an end-capping agent, 3,4,3′,4′-benzophenonetetracarboxylic dianhydride (BTDA), metaphenylene diamine (meta PDA), and 4,4′-(1,3-phenylene-bis(1-methylethylidene))bisaniline (bis-M), and mixtures thereof, or a reaction product of the monomeric mixture;
a second prepolymer component comprising a monomeric mixture of diamine component comprising 4,4′-(1,3-phenylene-bis(1-methylethylidene))bisaniline (bis-M), 1,4-phenylenediamine (para-PDA), derivatives thereof, and mixtures thereof, a dianhydride component comprising 3,4,3′,4′-biphenyltetracarboxylic dianhydride (BPDA), derivatives thereof, and mixtures thereof, and an end group component comprising a monomethyl ester of 5-norbornene 2,3-dicarboxylic acid (NE), derivatives thereof, and mixtures thereof.

3. The method according to claim 1 wherein the polyimide resin system includes:
a first prepolymer component comprising a monomeric mixture of 2,3-3′,4′-biphenyltetracarboxylic dianhydride (a-BPDA); a diamine selected from an amino phenoxy benzene (APB), metaphenylene diamine (meta-PDA), derivatives thereof, and mixtures thereof, and an end group selected from phenyl ethynyl phtalic anhydride (PEPA), derivatives thereof, and mixtures thereof, or a reaction product of the monomeric mixture;
a second prepolymer component comprising a monomeric mixture of a dianhydride component including at least one of a pyromellitic dianhydride, 3,4,3′,4′-biphenyltetracarboxylic dianhydride (BPDA), and 3,4,3′,4′-benzophenonetetracarboxylic dianhydride (BTDA), derivatives thereof, and mixtures thereof, a diamine component including at least one of 1,4-phenylenediamine (para-PDA), amino phenoxy benzene (APB), derivatives thereof, and mixtures thereof, and an end group component including phenyl ethynyl phtalic anhydride (PEPA), derivatives thereof, and mixtures thereof.

4. The method according to claim 1 wherein the initial vacuum, pressure, and temperature conditions include:
setting the vacuum at an initial vacuum of between about 2.5″ Hg and about 5″ Hg, inclusive,
ramping the temperature from an initial temperature to about 190 F at a ramp rate between about 1 F/min and about 3 F/min, inclusive.

5. The method according to claim 1 wherein the initial vacuum, pressure, and temperature conditions include:
holding the temperature of the polyimide resin system to a solvent removal temperature between about 185° F. and about 190° F., inclusive, for about 1 hour.

6. The method according to claim 1 wherein the second vacuum, pressure, and temperature conditions include:
ramping the temperature to a predetermined imidizing temperature of between about 360° F. and 480° F., inclusive, and increasing the vacuum when the polyimide resin system attains a predetermined temperature less than the imidizing temperature.

7. The method according to claim 1 wherein the third vacuum, pressure, and temperature conditions include:
ramping the temperature to a predetermined consolidating temperature greater than about 470° F., and applying pressure when the polyimide resin system reaches a predetermined temperature between about 470° F. and 510° F., inclusive.

8. The method according to claim 1 wherein the fourth vacuum, pressure, and temperature conditions include:
ramping the temperature to a predetermined crosslinking temperature of from about 600° F. to about 650° F., inclusive under a predetermined pressure.

9. The method according to claim 1 wherein:
the first vacuum, pressure, and temperature conditions include setting the vacuum at an initial vacuum of between about 2.5″ Hg and about 5″ Hg, inclusive, and ramping the temperature from an initial temperature to about 190 F at a ramp rate between about 1 F/min and about 2 F/min, inclusive, and holding the temperature of the polyimide resin system to a solvent removal temperature between about 185° F. and about 190° F., inclusive, for about 1 hour;
the second vacuum, pressure, and temperature conditions include ramping the temperature to a predetermined imidizing temperature of between about 360° F. and 480° F., inclusive, and increasing the vacuum when the polyimide resin system attains a predetermined temperature less than the imidizing temperature;
the third vacuum, pressure, and temperature conditions include ramping the temperature to a predetermined consolidating temperature greater than about 470° F., and applying pressure when the polyimide resin system reaches a predetermined temperature between about 470° F. and 510° F., inclusive; and
the fourth vacuum, pressure, and temperature conditions include ramping the temperature to a predetermined crosslinking temperature of from about 600° F. to about 650° F., inclusive under a predetermined pressure.

10. The method according to claim 1 wherein at least the initial vacuum, pressure, and temperature conditions are different when fabricating the component having less than about 12 fiber-reinforced layers and when fabricating the component having greater than 12 fiber-reinforced layers.

11. The method according to claim 1 wherein the initial vacuum, pressure, and temperature conditions includes variable vacuum conditions.

12. A turbine engine composite component formed by the method according to claim 1.

13. A turbine engine composite component formed by the method according to claim 9.

14. A method for designing a cure cycle for fabricating a composite component comprising a polyimide resin system, wherein the cure cycle includes a solvent removal portion, an imidization portion, a consolidation portion, and a solidification portion, the method comprising:
a) determining a plurality of first relationships between applied vacuum verses mass flow rate to model solvent removal for a preselected polyimide resin system;
b) determining a plurality of second relationships between time for 95% reaction completion verse temperature to model imidization reaction kinetics for the preselected polyimide resin system;
c) determining a plurality of third relationships between reaction temperatures, time until pressure is applied, applied pressure level, and heating rates to model consolidation for the preselected polyimide resin system;
d) determining a plurality of fourth relationships between heating rates, stress behavior, and component geometry to model solidification for the preselected polyimide resin system; and
e) using the relationships determined in (a)-(d) to provide an overall cure cycle including vacuum, pressure, and temperature conditions for the polyimide resin system.
